(19) United States
(12) Patent Application Publication
(10) Pub. No.: US 2026/0346987 A1
(43) Pub. Date: Nov. 5, 2026

(54) PANEL, IN PARTICULAR FOR A FURNITURE ELEMENT, IN PARTICULAR A SEAT UNIT

(71) Applicant: Safran Seats, Plaisir (FR)

(72) Inventors: Gérald Cotta, Moissy-Cramayel (FR); Laura Olivas, Moissy-Cramayel (FR); Rachel James, Moissy-Cramayel (FR); Shamini Thanapalasingam, Moissy-Cramayel (FR)

(21) Appl. No.: 19/488,190

(22) PCT Filed: Jun. 4, 2024
(86) PCT No.: PCT/EP2024/065337

§ 371 Date: Nov. 26, 2025

(30) Foreign Application Priority Data
Jun. 5, 2023 (FR) FR2305592

(51) Int. Cl. B64D 11/06

(52) U.S. Cl. CPC B64D 11/0606; B64D 11/0602

(57) ABSTRACT

The present invention relates to a furniture element, in particular for an aircraft seat unit comprising at least one main panel at least made of a felt-based material comprising an agglomeration of non-woven fibres. In some cases, the fibers are able to agglomerate under the effect of heat due to their intrinsic property or the addition of a binder.

The present invention relates to a panel, particularly for a furniture element, in particular of a seat unit. The invention finds a particularly advantageous, but not exclusive, application with structural panels forming furniture elements, in particular privacy shells and/or consoles belonging to seat units, in particular of the “business class” and “first class” type of an aircraft cabin.

In a manner known per se, a seat unit comprises at least one seat associated with a privacy shell. The privacy shell extends at least partially around the seat, so as to delimit an at least partially enclosed private space around the passenger. Such a configuration ensures the privacy of the passenger in the seat.

The privacy shell is conventionally formed by thermoformed plastic panels or composite panels of “sandwich” type, that is to say panels made up of a stack of layers of different materials.

Such materials have the disadvantage of having a significant mass, which degrades aircraft performance in terms of fuel consumption and pollutant emissions. Therefore, there is a need to reduce the weight of the seat unit components without excessively modifying the manufacturing methods for these types of components.

The objective of the invention is to effectively remedy the aforementioned drawbacks by providing a furniture element, particularly for an aircraft seat unit, comprising at least one main panel, the main panel being made at least of a felt-based material comprising an agglomeration of non-woven fibers, said fibers being able to agglomerate under the effect of heat due to their intrinsic property or the addition of a binder.

The invention thus configured contributes to the optimization of performance by reducing the overall mass of the aircraft, thus reducing fuel consumption leading to a reduction in emissions of polluting particles (CO, CO2, Nox . . . ).

According to one embodiment of the invention, the felt-based material is shaped by means of industrial processes such as thermocompression or thermoforming.

According to one embodiment of the invention, the constituent material of the main panel comprises natural fibers made from a material chosen from hemp, flax, wool or bamboo.

According to one embodiment of the invention, the constituent material of the main panel comprises mineral fibers and/or fibers made from aramid material.

According to one embodiment of the invention, the constituent material of the main panel comprises fibers made from a plastic material chosen from polyamide, polyethylene, polyurethane, polyetherimide, or polyethylene terephthalate.

According to one embodiment of the invention, the constituent material of the main panel includes at least one binder, in particular a resin.

According to one embodiment of the invention, said furniture element comprises an additional panel fixed to one side of the main panel.

According to one embodiment of the invention, the additional panel is made of felt,
the main panel comprising an alternating pattern of hollows and flats to create a wavy shape,
the additional panel comprising alternating hollows and flats to create a wavy shape,
the main panel and the additional panel being arranged back to back in such a way that the flats of the main panel are in contact with the flats of the additional panel and the hollows of the main panel and the additional panel arranged at a distance from each other delimit cells so as to stiffen the assembly of two panels.

According to one embodiment of the invention, said furniture element comprises a reinforcing element, in particular having a rigidity greater than that of the main panel, said reinforcing element being fixed to one face of the main panel.

According to one embodiment of the invention, the reinforcing element constitutes a connecting interface and/or a contact interface between the main panel and another component of the furniture element.

According to one embodiment of the invention, the furniture element comprises a comfort element, notably made of a flexible material, said comfort element being placed on one side of the main panel.

According to one embodiment of the invention, the main panel comprises a deformed portion projecting from one face of the main panel, notably to form an armrest.

According to one embodiment of the invention, the main panel comprises at less a hinge consisting of a mechanical weakness zone, in particular comprising at least one groove.

According to one embodiment of the invention, the mechanical weakness zone is achieved by local removal of material in a thickness of the main panel and/or at constant thickness by local deformation of the main panel.

According to one embodiment of the invention, the main panel comprises a gripping area, in particular consisting of an end portion of the main panel, in particular an end portion of the main panel at least partially folded.

According to one embodiment of the invention, the main panel comprises a closing device.

According to one embodiment of the invention, the closing device comprises an opening in the main panel, said opening being capable of cooperating with a locking element, in particular having at least partly a trapezoidal, dovetail and/or ball shape.

According to one embodiment of the invention, the furniture element is chosen among a console, a shell, a footrest and/or a door.

The objective of the invention is also an aircraft seat unit including a furniture element as previously defined.

The invention will be better understood and other characteristics and advantages will appear by reading the following detailed description, which includes embodiments given for illustrative purposes with reference to the accompanying Figures, presented as way of non-limiting examples, which may serve to complete the understanding of the present invention and the description of its implementation and eventually contribute to its definition, wherein:

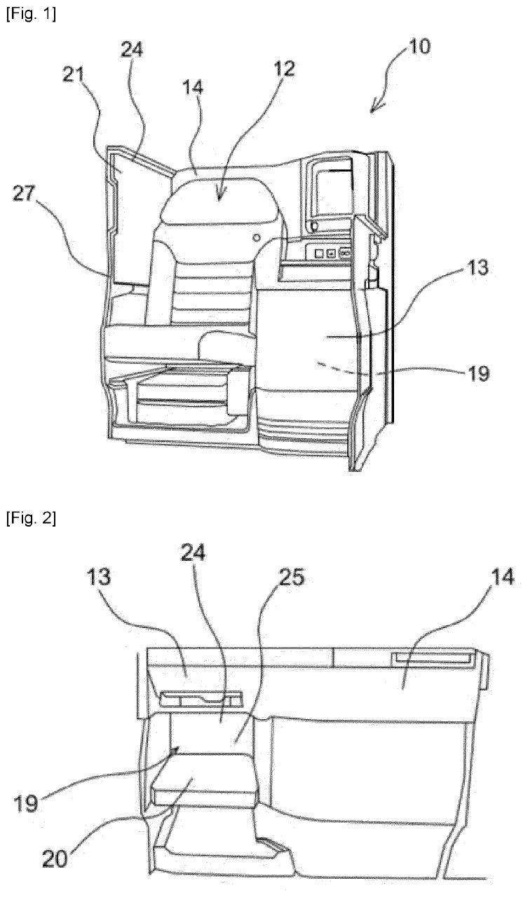

FIG. 1 is a perspective view of a seat unit comprising at least one furniture element having a structural panel according to the invention;

FIG. 2 is a perspective view of a footrest inside a seat unit having a panel according to the invention;

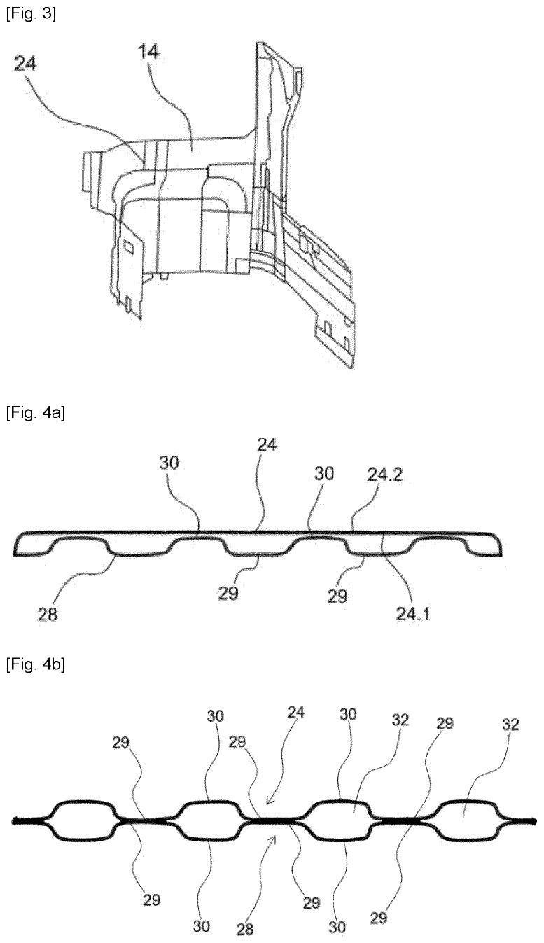

FIG. 3 is a perspective view of a covering piece of the seat unit in FIG. 1;

FIG. 4a is a side view of the panel according to a first embodiment of the invention;

FIG. 4b is a side view of the panel according to a second embodiment of the invention;

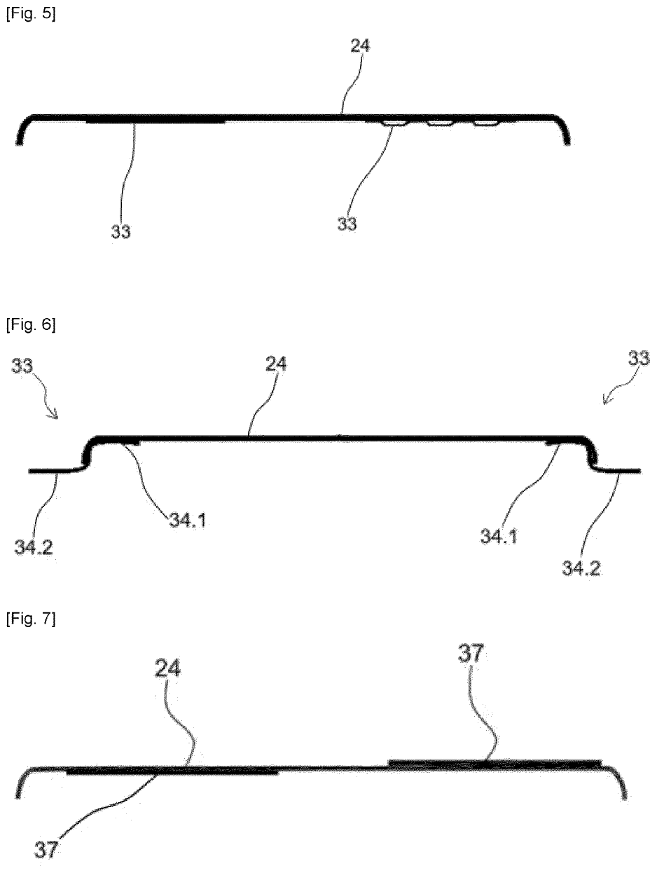

FIG. 5 is a side view of the panel according to a third embodiment of the invention;

FIG. 6 is a side view of the panel according to a fourth embodiment of the invention;

FIG. 7 is a side view of a panel according to a fifth embodiment of the invention;

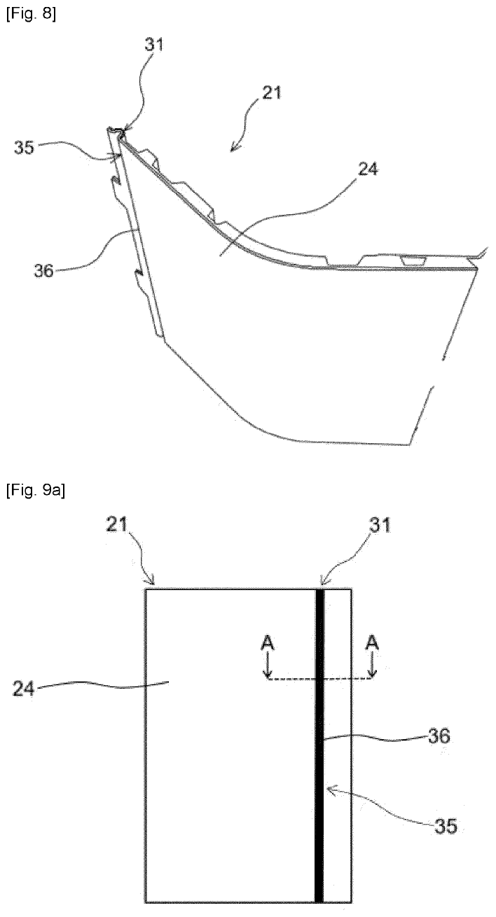

FIG. 8 is a perspective view of a first embodiment of a door according to the invention;

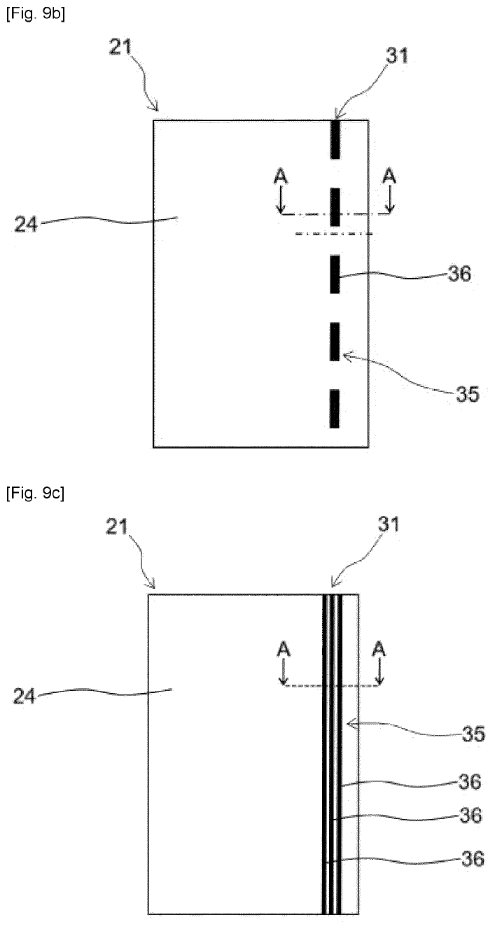

FIG. 9a FIG. 9b FIG. 9c FIGS. 9a, 9b, and 9c are front views of the door in FIG. 8 according to different embodiments;

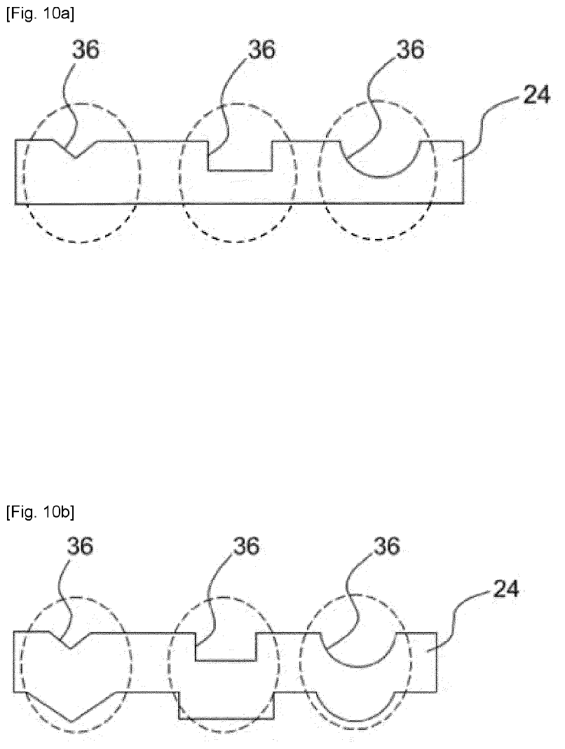

FIG. 10a FIG. 10b FIGS. 10a and 10b show different groove shapes along a section plane A-A in FIGS. 9a-9c;

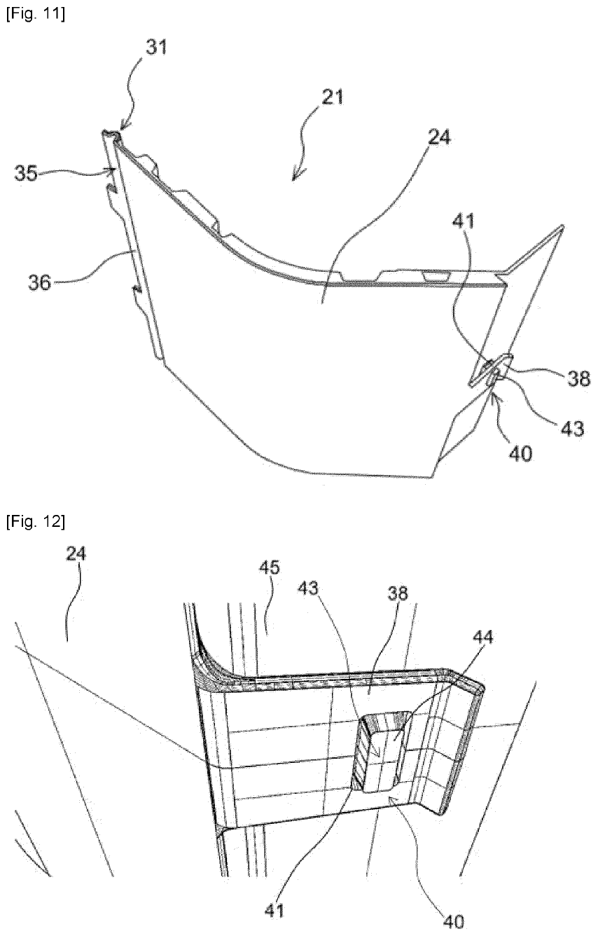

FIG. 11 is a perspective view of a second embodiment of a door according to the invention;

FIG. 12 is a detailed perspective view of a closing device according to the invention;

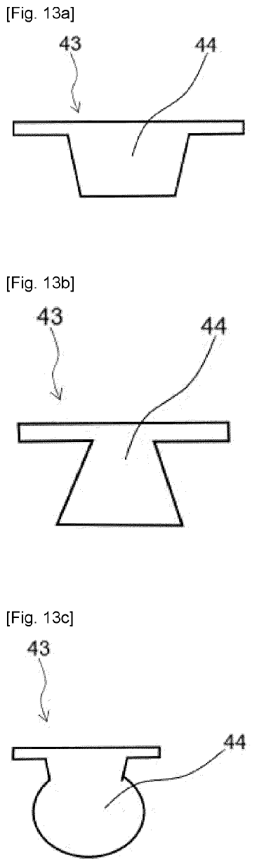

FIG. 13a FIG. 13b FIG. 13c FIGS. 13a, 13b, and 13c are detailed views of different shapes of a locking element of the closing device in FIG. 12; and

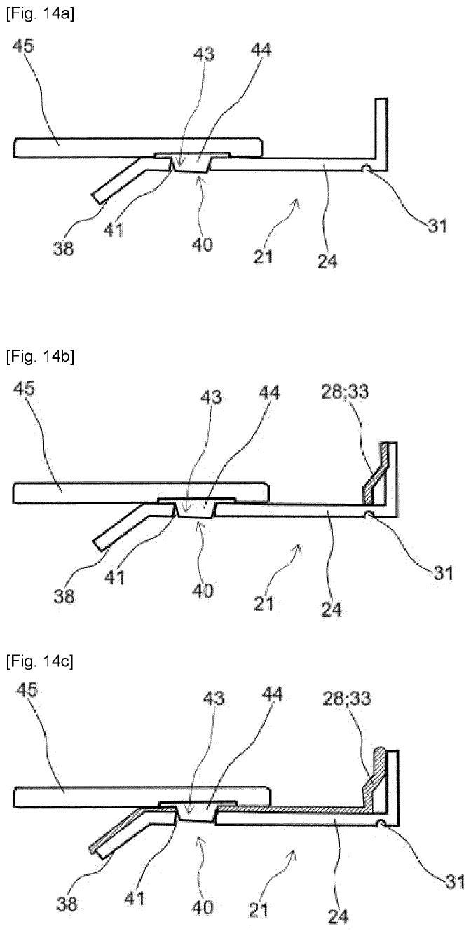

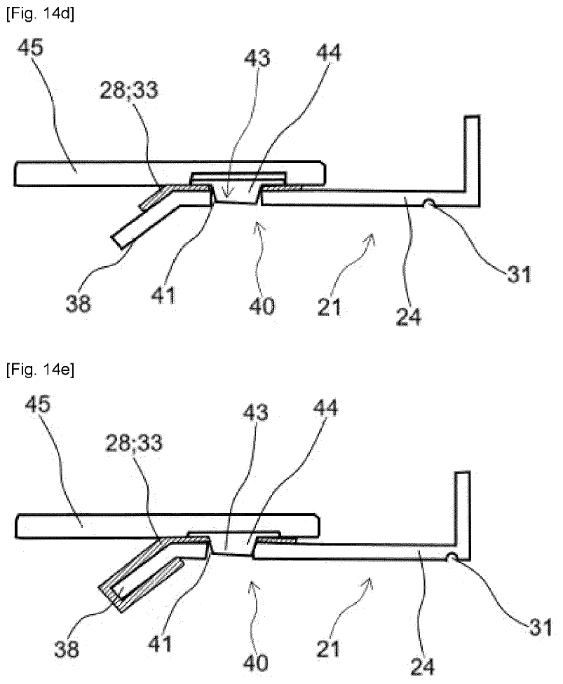

FIG. 14a FIG. 14b FIG. 14c FIG. 14d FIG. 14e FIGS. 14a, 14b, 14c, 14d and 14e are schematic representations illustrating different embodiments of a door equipped with a closing device according to the invention.

It should be noted that the structural and/or functional elements common to the different embodiments have the same reference numerals. Thus, unless otherwise stated, such elements have identical structural, dimensional and material properties.

FIG. 1 is a perspective view of a seat unit 10 comprising at least one furniture element having a main panel 24, in particular a structural panel 24, according to the invention.

More specifically, FIG. 1 shows the seat unit 10 comprising a seat 12 associated with a console 13 extending along one side of the seat 12. In addition, a shell 14, also called a privacy shell, extends at least partially around the seat 12 so as to delimit a space that is at least partially enclosed around the passenger. This configuration ensures the privacy of the passenger in seat 12.

The shell 14 is an example of a furniture element according to the invention.

The console 13 has a housing 19 in which is arranged a footrest 20, said housing being called ottoman, on which a rear passenger can rest his/her feet.

The seat unit 10 may include a door 21. In particular, the door 21 is mounted so as to move in translation relative to the shell 14, by means of a translational movement mechanism, for example having the form of a slide or a trolley capable of moving along a rail.

The door 21 is located on the side of an aisle in an aircraft cabin in which seat unit 10 is arranged.

The door 21 can be a door of the seat unit 10, giving access to the aisle of the aircraft cabin, or a door of a furniture element, such as a closet, inside the aircraft cabin.

In the closed position, the door 21 enables the passenger to be isolated from the aisle of the aircraft cabin. In the open position, the door 21 enables the passenger to access to the aisle of the aircraft cabin.

According to the invention, the furniture element comprises the main panel 24. In particular, the main panel 24 can be made of a felt-based material, formed by an agglomeration of fibers. The fibers are capable of agglomerating under the effect of heat due to their intrinsic property or the addition of a binder.

The main panel 24 can be made of a non-woven material made from natural and/or synthetic fibers. More specifically, the main panel 24 can be obtained by a process of matting and compacting fibers under heat, pressure, and moisture. The main panel 24 is therefore free of weft or warp yarns.

The furniture element can take the form of the shell 14, the footrest 20, the door 21, a flap, a storage door and/or any other furniture element suitable for the application.

In addition, the furniture element can take the form of a covering element for the shell 14 and/or a false floor, such as a lower part of the footrest 20.

The main panel 24 can constitute a structural component of the furniture element. Thus, the main panel 24 is capable of supporting loads and contributing to the overall strength and rigidity of the furniture element.

The main panel 24 may have a low thickness compared to a length and/or width of the main panel 24. Consequently, it is possible to consider that the main panel 24 extends essentially at least in part in a plane.

As can be seen in FIG. 4a, the main panel 24 has an internal face 24.1 and an external face 24.2, opposite the internal face 24.1.

In the example embodiment of door 21, the inner face 24.1 is for example facing the seat 12 and the external face 24.2 is facing an aisle of the aircraft cabin.

The main panel 24 is preferably thermo-compressed or thermoformed, that is to say it is preheated before being shaped inside a mold.

The main panel 24 may include natural fibers, such as hemp, flax, wool, or bamboo fibers and/or any other natural material suitable for the application.

Although the main panel 24 can be made using a method which does not require a specific binder, the main panel 24 can contain a binder that ensures a bond between the natural fibers. The binder is for example an acrylic or phenolic resin.

In particular, the mass percentage of the binder may be between 5% and 40%, preferably between 20% and 25%, of the total mass of the main panel 24.

According to another embodiment, the main panel 24 may contain mineral fibers, such as glass fibers and/or fibers made from an aramid material, including para-aramid or meta-aramid. Glass fibers and/or aramid fibers may be used alone or in combination with the other types of fibers listed in this description.

According to another embodiment, the main panel 24 may also include fibers made of a plastic material. The plastic material may be a thermoplastic or thermosetting material. Advantageously, the fibers are made of a material selected from polyamide, also designated by the acronym “PA”, polyethylene, also designated by the acronym “PE”, polyurethane, also designated by the acronym “PU”, polyetherimide, also designated by the acronym “PEI”, or polyethylene terephthalate, also designated by the acronym “PET”. It is possible to use a material entirely composed of fibers made of the aforementioned plastic material. Alternatively, plastic fibers of different types may be mixed with each other and/or with natural fibers and/or mineral fibers and/or fibers made from aramid material.

In the case of a material comprising plastic fibers, the main panel 24 may contain a binder to ensure a bond between the fibers. However, it may not be necessary to use a binder since the plastic fibers will bond together when heated.

Alternatively, the main panel 24 may comprise a mixture of fibers made from a plastic material and natural fibers. Such a mixture may be made so as to optimize the thermoformability of the main panel 24, if necessary.

According to another embodiment, the main panel 24 comprises carbon fibers, possibly combined with a resin. The carbon fibers may be flame-retardant. The resin may be a thermoplastic or thermosetting material.

In particular, the mass percentage of the resin may be between 5% and 40%, preferably between 20% and 25%, of the total mass of the main panel 24.

Such carbon fibers may have fire-resistance properties and high thermal stability, so that they do not burn easily. When such carbon fibers are exposed to high temperatures, they decompose without flames and form a layer of carbon behaving as thermal insulation, thus slowing the spread of fire.

Such carbon fibers enable to manufacture a main panel 24 having structural, lightweight and thermal resistance properties.

Regardless of the material chosen for the fibers, namely fibers made from plastic material and/or natural fibers, at least part of the fibers may be made from recycled materials.

In the embodiment in FIG. 1, the door 21 comprises the main panel 24 made of a felt-based material. The main panel 24 may include a portion 27 projecting from the main panel 24, in particular the inner face 24.1. The portion 27 constitutes a projecting deformation suitable for forming for example an armrest for the passenger in the seat 12.

FIG. 2 is a perspective view of the footrest 20 inside the seat unit 10 having the main panel 24 according to the invention.

More particularly, in the embodiment in FIG. 2, a wall 25 of the housing 19 comprises the main panel 24 made of a felt-based material.

FIG. 3 is a perspective view of a covering part of the unit seat 10 according to the invention.

More specifically, in the embodiment in FIG. 3, the shell 14 includes a covering piece consisting of the main panel 24 made of a felt-based material.

FIG. 4a is a side view of the main panel 24 according to a first embodiment of the invention.

More specifically, an additional panel 28 is fixed to one face of the main panel 24. Preferably, the additional panel 28 is fixed to the inner face 24.1 of the main panel 24. Thus, the additional panel 28 is not visible from outside the seat unit 10, i.e. in particular not visible from the aisle of the aircraft cabin.

The additional panel 28 can be made of a felt-based material. The felt-based material may be the same as or different from the material of the main panel 24.

According to an exemplary embodiment, as shown in FIG. 4a, the additional panel 28 may have a corrugated shape in order to stiffen the main panel 24.

To this end, the additional panel 28 has an alternating pattern of hollows 30 and flats 29. In such a configuration, the hollows 30 come into contact with a face of the main panel 24 while the flats 29 are projecting from the face of the main panel 24 and therefore at a distance therefrom. Preferably, the additional panel 28 covers at least 80%, preferably the totality, of the area of the face of the main panel 24.

In the embodiment in FIG. 4b, the main panel 24 shows an alternating pattern of hollows 30 and flats 29 so as to create a wavy shape. The additional panel 28, also made of felt, shows an alternating pattern of hollows 30 and flats 29 so as to create a wavy shape.

The main panel 24 and the additional panel 28 are arranged in such a way that the flats 29 of the main panel 24 are in contact with the flats 29 of the additional panel 28. The hollows 30 of the main panel 24 and of the additional panel 28 arranged at a distance from each other delimit cells 32 so as to stiffen the assembly of two panels 24, 28.

FIG. 5 is a side view of the main panel 24 according to a second embodiment of the invention.

More specifically, in the embodiment in FIG. 5, a reinforcing element 33 is fixed to one face of the main panel 24. More specifically, the reinforcing element 33 is located in specific areas of the main panel 24 in order to provide localized reinforcement of such specific areas.

The reinforcing element 33 is made of a rigid material, such as a plastic material and/or a composite material. In particular, the reinforcing element 33 has a greater rigidity than that of the main panel 24.

Preferably, the local reinforcing element 33 is fixed to the internal face 24.1 of the main panel 24. Thus, the local reinforcing element 33 is not visible from outside the seat unit 10.

The local reinforcing element 33 can be constituted by a panel of smaller size than the main panel 24. The local reinforcing element 33 can be a flat panel, as shown on the left in FIG. 5, or a corrugated panel, as shown on the right in FIG. 5.

Alternatively or in addition, the local reinforcing element 33 may be a panel fitting the curves of the main panel 24.

The local reinforcing element 33 may be arranged for example behind the deformed portion 27 of the main panel 24 so as to form an armrest.

FIG. 6 is a side view of the main panel 24 according to a third embodiment of the invention.

More specifically, in the embodiment shown in FIG. 6, the reinforcing element 33 constitutes a connecting interface and/or a contact interface between the main panel 24 and another furniture element and/or with a component of such a furniture element.

The reinforcing element 33 includes at less: a connecting part 34.1 to be superimposed with the main panel 24,
a joining part 34.2 not to be superimposed with the main panel 24.

The connecting part 34.1 can be fixed to a portion of the panel main 24 by gluing, riveting and/or any other means suitable for the application.

The joining portion 34.2 may include fixing means to the other furniture element and/or the component of such a furniture element, such as openings for the passage of a fixing member or an integration of a fixing means by snapping, screwing, riveting and/or other.

The reinforcing element 33 may also take the form of a reinforcing tube made of metal, in particular aluminum and/or a composite material.

FIG. 7 is a side view of the main panel 24 according to a fourth embodiment of the invention.

More specifically, in the embodiment in FIG. 7, a Comfort element 37 is arranged on the main panel 24.

The comfort element 37 may be made of a flexible material, such as foam, rubber material, and/or elastomer material. The comfort element 37 may also comprise several layers of different materials (among those mentioned above) and not just a single material. One of the layers of the material complex of the comfort element 37 may be high-density foam, which may or may not be perforated.

According to a particular embodiment, the comfort element 37 may be placed on a face of the main panel 24 facing the passenger, in particular on the inner face 24.1 of the main panel 24. In such an arrangement, the comfort element 37 may be placed in particular on a side face of the shell 14, so that the passenger can rest part of her/his body on the comfort element 37.

According to another particular embodiment, the comfort element 37 may be arranged on a face of the main panel 24 facing an aisle of the aircraft cabin.

Alternatively or in addition, the comfort element 37 may have a function of covering all or part of the main panel 24.

For this purpose, the comfort element 37 is a finishing layer attached to all or part of the main panel 24 by gluing and/or any other means suitable for the application. In particular, the comfort element 37, as a finishing layer, can be removably attached to the main panel 24. Such an arrangement enables an easy replacement of the finishing layer as needed.

In particular, the comfort element 37 can be made of fabric, suede, leather, “imitation” leather and/or any other material for an appearance treatment of the main panel 24.

FIG. 8 is a perspective view of a first embodiment of the door 21 according to the invention.

More particularly, in the embodiment in FIG. 8, the door 21 comprises at least one main panel 24 equipped with a hinge 31.

In particular, the hinge 31 is constituted by a mechanical weakness zone 35, suitable for a localized folding of the main panel 24. Thus, in the event of an emergency situation and/or when the door movement mechanism 21 is malfunctioning, a passenger may apply a force, in particular a force perpendicular to the plane of the door 21, so as to rotate the sliding door 21 around the hinge 31 in order to clear the access to the aisle of the aircraft cabin.

In normal use of the door 21, i.e. when no significant force is applied to the door 21, the hinge 31 does not flex.

The mechanical weakness zone 35 extends along at least part of the height of the door 21, measured in a vertical direction. Preferably, the mechanical weakness zone 35 extends along the entire height of the door 21.

According to a particular embodiment, the mechanical weakness zone 35 may be a groove 36 on a part of the thickness of the main panel 24.

FIGS. 9a, 9b, and 9c are front views of the door 21 in FIG. 8 according to different embodiments.

More particularly, in the embodiment in FIG. 9a, the groove 36 can be continuous.

Alternatively, in the embodiment in FIG. 9b, the groove 36 may be discontinuous.

Finally, in the embodiment in FIG. 9c, the mechanical weakness zone 35 may include a plurality of grooves 36, in particular parallel to each other. Such an arrangement makes it possible to distribute the forces when the door 21 is opened.

FIGS. 10a and 10b show different shapes of the groove 26 along a section plane A-A in FIGS. 9a-9c.

More particularly, in the embodiment in FIGS. 10a and 10b, the groove 36 may have a V-shaped, U-shaped, or C-shaped cross-section rotated by 90°. In particular, the V-shaped and U-shaped groove 36 may also have rounded corners.

In the embodiments in FIG. 10a, the groove 36 is made by local removal of material in a thickness of the main panel 24. In such an arrangement, the main panel 24 has a reduced thickness at the groove 36 compared to the overall thickness of the main panel 24.

In the embodiments in FIG. 10b, the groove 36 is made with a constant thickness relative to the rest of the main panel 24. In such an arrangement, the main panel 24 has the same thickness at the groove 36 as in the rest of the main panel 24. In this case, the groove 36 may be obtained by a local deformation of the main panel 24.

FIG. 11 is a perspective view of a second embodiment of the door 21 equipped with a closing device 40 according to the invention, shown in a detailed perspective view in FIG. 12.

More particularly, in the embodiment in FIG. 11 and 12, the door 21 includes at least one main panel 24 which may include a gripping area 38, forming for example a handle, for a passenger or staff member.

The gripping area 38 is constituted for example by an end portion of the main panel 24. The gripping area 38 of the main panel 24 may in particular have a reduced width compared to the rest of the main panel 24.

Furthermore, the gripping area 38 may be folded at least in part so that at least part of the gripping area 38 forms a non-zero angle with respect to the rest of the main panel 24.

Furthermore, the gripping area 38 may project from one edge of the main panel 24.

Furthermore, a closing device 40 is provided to ensure that the door 21 remains in the closed state. Specifically, the closing device 40 may include an opening 41, in particular in the main panel 24, especially near or within the gripping area 38. Preferably, the opening 41 is a through opening.

The opening 41 is provided for cooperating with a locking element 43. According to one embodiment, the locking element 43 is suitable for being fixed to a fixed element 45 in the aircraft cabin, for example a wall of the aircraft cabin or a wall of a furniture element, such as the seat unit 10.

FIGS. 13a, 13b, and 13c are detailed views of different shapes of the locking element 43 of the closing device 40 according to the invention.

According to the various embodiments shown, the locking element 43 comprises a stud 44.

In the embodiment in FIG. 13a, the stud 44 may have a trapezoidal shape, in particular with a small side located opposite a face of the fixed element 45 to which the locking element 43 is fixed.

In the embodiment in FIG. 13b, the stud 44 may have a dovetail shape.

In the embodiment in FIG. 13c, the stud 44 may have a ball shape.

Alternatively, the stud 44 may have any other shape suitable for the application.

When the door 21 is in the closed state, the locking element 43 is inserted into the corresponding opening 41 in the closing device 40. In order to open the door 21, the passenger and/or a staff member can grasp the gripping area 38 and pull it so as to disengage the locking element 43 from the opening 41.

The door 21 may include a hinge 31 as in the previous embodiment, so as to fold the door 21 around the hinge in order to open the door 21.

FIGS. 14a, 14b, 14c, 14d and 14e are schematic representations illustrating different embodiments of the door 21 equipped with the closing device 40 according to the invention.

More specifically, in the embodiment in FIG. 14a, the door 21 only has at least one main panel 24.

Furthermore, in the embodiment in FIG. 14b, the door 21 comprises at least one main panel 24 and a reinforcing piece at the hinge 31. The reinforcing piece at the hinge 31 may be constituted by the additional panel 28 and/or the reinforcing element 33, as described previously.

Furthermore, in the embodiment in FIG. 14c, the door 21 comprises at least one main panel 24, an additional panel 28 and/or a reinforcing element 33. The additional panel 28 may be fixed to the inner face 24.1 of the main panel 24. Similarly, in addition or alternatively, the reinforcing element 33 may be fixed to the inner face 24.1 of the main panel 24.

According to another embodiment in FIG. 14d, the door 21 comprises at least one main panel 24, an additional panel 28 and/or a reinforcing element 33. The additional panel 28 may be located at the closing device 40. Similarly, in addition or alternatively, the reinforcing element 33 may be located at the closing device 40.

Finally, in the embodiment in FIG. 14e, the door 21 comprises at least one main panel 24, an additional panel 28, and/or a reinforcing element 33. The additional panel 28 may be located at the closing device 40 and surround the gripping area 38 in order to stiffen it locally. Similarly, in addition to or alternatively, the reinforcing element 33 may be located at the closing device 40 and surround the gripping area 38 in order to stiffen it locally.

The invention also relates to a seat unit comprising a furniture element according to the invention.

The present invention has been described in relation to a seat unit 10. However, it finds application with any furniture element comprising at least one main panel made of at least one felt-based material.

Of course, the different characteristics, variants and/or embodiments the present invention may be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A furniture element, in particular for an aircraft seat unit comprising at least one main panel is made at least of a felt-based material comprising an agglomeration of non-woven fibers, said fibers being able to agglomerate under the effect of heat due to their intrinsic property or the addition of a binder.

2. The furniture element according to claim 1, wherein the felt-based material is shaped by industrial processes of the thermocompression or thermoforming type.

3. The furniture element according to claim 1, wherein the constituent material of the main panel comprises natural fibers made from a material selected from hemp, flax, wool or bamboo.

4. Furniture element according to claim 1, wherein the constitutive material of the main panel comprises mineral fibers and/or fibers made from an aramid material.

5. The element according to claim 1, wherein the constitutive material of the main panel comprises fibers made of a plastic material selected from polyamide, polyethylene, polyurethane, polyetherimide, or polyethylene terephthalate.

6. The furniture element according to claim 1, wherein the constitutive material of the main panel comprises at least one binder, in particular a resin.

7. The furniture element according to claim 1, wherein it comprises an additional panel fixed to one face of the main panel.

8. The furniture element according to claim 7, chara wherein the additional panel is made of felt,
the main panel comprising an alternating pattern of hollows and flats create a wavy shape,
the additional panel comprising an alternating pattern of hollows and flats to create a wavy shape,
the main panel and the additional panel being arranged back to back in such a way that the flats of the main panel are in contact with the flats of the additional panel and the hollows of the main panel and the additional panel arranged at a distance from each other delimit cells so as to stiffen the assembly of two panels.

9. The furniture element according to claim 1, wherein it comprises a reinforcing element, in particular having a greater rigidity than the main panel, said reinforcing element being fixed to one face of the main panel.

10. The furniture element according to claim 9, wherein the reinforcing element constitutes a connecting interface and/or a contact interface between the main panel and another component of the furniture element.

11. The furniture element according to claim 1, wherein it includes a comfort element, in particular made of a flexible material, arranged on one face of the main panel.

12. The furniture element according to claim 1, wherein the main panel has a deformed portion projecting from a face of the main panel, in particular to form an armrest.

13. The furniture element according to claim 1, wherein the main panel comprises at least one hinge consisting of a mechanical weakness zone, said hinge in particular comprising at least one groove.

14. The furniture element according to claim 13, wherein the mechanical weakness area is achieved by local removal of material in a thickness of the main panel and/or at constant thickness by local deformation of the main panel.

15. The furniture element according to claim 1, wherein the main panel has a gripping area, in particular consisting of an end portion of the main panel, in particular an end portion of the main panel at least partially folded.

16. The furniture element according to claim 1, wherein the main panel includes a closing device.

17. The furniture element according to claim 16, wherein the closing device comprises an opening in the main panel, capable of cooperating with a locking element, in particular having at least partly a trapezoidal shape, a dovetail shape and/or a ball shape.

18. The furniture element according to claim 1, wherein it is selected from a console a shell, a footrest and/or a door.

19. An aircraft seat unit comprising a furniture element as defined claim 1.
